(19) United States
(12) Patent Application Publication
(10) Pub. No.: US 2026/0245767 A1
(43) Pub. Date: Aug. 20, 2026

(54) SOURCES AND OPTICS FOR OPTICAL TRAP DISPLAY AND PRINTING

(71) Applicant: Brigham Young University (BYU), Provo, UT (US)

(72) Inventor: Daniel Smalley, Provo, UT (US)

(21) Appl. No.: 19/542,264

(22) Filed: Feb. 17, 2026

Related U.S. Application Data
(60) Provisional application No. 63/758,400, filed on Feb. 14, 2025.

(51) Int. Cl. G21K 1/30

(52) U.S. Cl. CPC G21K 1/30

(57) ABSTRACT

Techniques are directed to using a complex optical system to generate a combination of beams that define an optical tube having multiple volumetric regions configured to trap multiple particles. For example, the optical system can include an axicon that is configured to generate a pseudo-Bessel beam or a Bessel beam and another axicon superposed on the axicon. The other axicon can have an apex angle slightly larger than that of the axicon. The resulting beams can produce an optical tube that has a series of volumetric regions, each of which has a minimum of the beam intensity along an axis of the optical tube at which a particle is trapped within the volumetric region. By changing the phase of a portion of the light used to trap the particles, e.g., by using a spatial light modulator, the volumetric regions along with the particles can be moved along the optical tube.

### CROSS REFERENCE TO RELATED APPLICATION

This application claims the benefit of U.S. Provisional Application No. 63/758,400, filed on Feb. 14, 2025, the disclosure of which is hereby incorporated by reference in its entirety.

### BACKGROUND

Some display technologies predominantly rely on two-dimensional surfaces to present visual information, utilizing technologies such as Liquid Crystal Displays (LCDs) or Organic Light-Emitting Diodes (OLEDs) to modulate light across a planar screen. In the realm of fabrication, traditional three-dimensional printing (additive manufacturing) typically operates by depositing or curing material layer-by-layer upon a physical build platform, constrained by the need for mechanical support structures.

### SUMMARY

The concepts discussed herein are directed to a volumetric display system utilizing “optical tubes” to manipulate multiple particles in By utilizing interference patterns, such as those generated by Bessel beams or spatial light modulators, the system creates a series of volumetric regions—regions of low light intensity bordered by high-intensity “floors” and “ceilings”—along the length of a beam. These structures allow numerous opaque particles to be trapped at intensity minima via photophoretic forces, enabling the rapid rendering of 3D images through persistence of vision without the speed limitations of single-particle vector scanning. Furthermore, the concepts are directed to methods and systems to implement optical traps using incoherent light sources, such as arrays of micro LEDs or even sunlight, significantly reducing the cost and safety hazards associated with traditional laser-based systems while maintaining the high intensity needed for effective particle manipulation.

In a general aspect, a system can include a source, a first optical system, and a second optical system. The source can be configured to produce electromagnetic radiation. The first optical system can be configured to form a beam from the electromagnetic radiation produced by the source, the beam having an intensity profile along an axis, the beam causing a first particle to be localized at a first minimum of the intensity profile along the axis and a second particle to be localized at a second minimum of the intensity profile along the axis. The second optical system can be configured to cause the first particle and the second particle to move along the axis by moving the first minimum and the second minimum along the axis.

In another general aspect, a method can include forming a beam from electromagnetic radiation produced by a source, the beam having an intensity profile along an axis, the beam causing a first particle to be localized at a first minimum of the intensity profile along the axis and a second particle to be localized at a second minimum of the intensity profile along the axis. The method can also include causing the first particle and the second particle to move along the axis by moving the first minimum and the second minimum along the axis.

In another general aspect, a system can include an illumination source, and an optical system. The illumination source can include an array of illumination elements. The array of illumination elements can be configured to produce incoherent illumination. The optical system can be configured to form a first beam from the incoherent illumination produced by first illumination elements of the array of illumination elements and a second beam from the incoherent illumination produced by second illumination elements of the array of illumination elements, the optical system being further configured to combine the first beam and the second beam to form a region about foci of the first beam and the second beam in which a particle is localized.

In another general aspect, a system can include a source and an optical system. The source can be configured to produce electromagnetic radiation. The optical system can be configured to form a composite beam structure along an axis, the composite beam structure defining a first trapping region at a first axial position and a second trapping region at a second axial position. The optical system can be further configured to independently translate the first trapping region and the second trapping region along the axis such that a first particle confined in the first trapping region moves in a first direction while a second particle confined in the second trapping region simultaneously moves in a second direction different from the first direction, or remains stationary.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating an example three-dimensional raster imaging system using optical tubes that trap multiple particles, according to the implementations described herein.

FIG. 2 is a diagram illustrating an example raster imaging system that uses superposed axicons to produce beams that form the optical tubes that trap particles.

FIG. 3 is a diagram illustrating an example spatial light modulator for beam formation and phase change.

FIG. 4 is a diagram illustrating an example array of optical tubes with an illumination system for generating images.

FIG. 5 is a diagram illustrating an example system for generating an optical trap using incoherent illumination.

FIG. 6 is a diagram illustrating an example system for generating an optical trap using holographic optical elements.

### DETAILED DESCRIPTION

The technology described herein enables a new way to create 3D displays—images that float in mid-air—by using beams of light to trap and move tiny particles. Unlike older methods that grab a single particle and move it around rapidly to trace a shape (similar to drawing with a sparkler), this system creates “tubes” of light that function like invisible elevator shafts. Inside these tubes, the light is shaped to form a stack of “elevator cars,” which are essentially small pockets of darkness stacked on top of each other. Each of these “cars” can hold a separate particle, meaning a combination of beams of light can trap a whole column of particles at the same time. The system then moves all these cars up and down either separately, some or one at a time, or in unison, allowing the particles to work together to form an image.

Additionally, the technology described herein enables ways to build these displays using cheaper and safer light sources. Instead of relying solely on expensive and dangerous lasers, the system can use arrays of thousands of tiny LEDs (micro LEDs) or even sunlight. By focusing light from these sources very tightly, the system can create the strong forces needed to hold the particles in place without the high cost or safety risks of traditional lasers.

Some optical trapping systems, often referred to as optical tweezers, typically function by manipulating a single particle at a specific point within a light beam. These systems frequently utilize a “bottle beam” configuration, which generates a region of low light intensity (an intensity minimum) surrounded by high-intensity light to effectively cage the particle. To render an image, this single trapped particle is moved rapidly along a complex vector path, tracing out shapes in free space in a manner similar to drawing with a sparkler. Other traditional setups differ by holding transparent nanoscale beads at points of high light intensity (intensity maxima) using a combination of gradient and scattering forces. Nevertheless, these single-particle approaches face significant scalability and speed limitations, as they rely on mechanically or optically steering a single point through the entire volume of the image.

In some cases, raster imaging and printing is preferred over vector imaging and printing as described above. Conventional optical tubes, sometimes described as “straws of light,” function as long, hollow cylinders formed by focusing laser beams into extended geometries. These structures can be created using techniques such as vortex beams or single first-order Bessel beams, which generate “light walls” capable of confining a particle laterally along a specific axis. Within this continuous tube, a single particle is trapped and permitted to move back and forth along the length of the beam, effectively transitioning from a static point trap to a “line trap.”

In other cases, vector imaging may still be preferred. In such cases, conventional optical tweezers may be manipulated by an optical system that uses coherent laser light. Such coherent light may involve large enough amounts of power to generate the optical trap for a particle that can be 100 μm in size.

A technical problem with the conventional optical tubes is that the particle may travel the full length of the tube in order to generate an image. Given the length of such a tube, the amount of time required for such travel may result in a frequency that is lower than a desired refresh frequency for imaging. Additionally, the light utilized in these beam structures can be highly directional. Without proper scattering by the particles, the light may not be directed toward the viewer's eye, meaning the image might only be viewable if the observer is directly in line with the beam.

A technical problem with the conventional optical tweezers is that such coherent laser light can be expensive to use and maintain. For example, to effectively trap and illuminate a single particle, a system might require up to four separate lasers (one violet laser for trapping and red, green, and blue lasers for illumination). This reliance on discrete laser sources makes the system mechanically complex, not solid-state, and expensive to manufacture.

A technical solution to the technical problem of low refresh rates and scalability in conventional optical tubes involves a specific physical arrangement of optical elements configured to structurally transform a beam into a “nested” interference pattern. Unlike conventional systems that rely on a single trap, the present solution utilizes a first optical system comprising superposed diffractive or refractive elements, such as a first axicon and a second axicon, where the second axicon has an apex angle distinct from (e.g., slightly larger than) the first. This specific geometric difference causes the wavefronts to interfere at precise intervals along the propagation axis, physically generating a periodic series of high-intensity regions (“floors” and “ceilings”) and low-intensity volumetric regions (“elevator cars”). Furthermore, the system employs a specific modulation technique—such as dynamically altering the phase of the rays via a spatial light modulator—to translate these interference nodes along the axis without altering the physical position of the axicons. This configuration enables the simultaneous, rigid-body transport of multiple particles, thereby mechanically improving the refresh speed of the volumetric display.

A technical solution to the technical problem of complexity and safety in conventional optical tweezers involves a solid-state optical architecture configured to synthesize high-intensity trapping potentials from incoherent sources. Rather than relying on the coherence of single lasers, the system utilizes a high-density array of illumination elements (e.g., 30,000 or more micro LEDs) coupled to a specific optical system, such as an array of holographic optical elements (HOEs) or superimposed lenses and prisms. This optical system is configured to perform “many-to-one” imaging, where the incoherent output from multiple spatially distinct elements is geometrically mapped to converge at a single focal volume. By spatially arranging these focal points to surround a target zone, the system physically constructs a “minima trap”—a dark volumetric region caged by high-intensity barriers—purely through intensity summation rather than coherent interference. This architecture allows for the dynamic manipulation of the trap's position and color by electronically addressing specific pixels within the array, thereby replacing mechanical beam steering with solid-state electronic switching.

A technical advantage of this specific optical tube configuration is an improvement in the functioning of volumetric displays. By trapping multiple particles in sequential “elevator cars,” the system shifts the operating principle from single-particle vector scanning to multi-particle raster scanning. This physical transformation reduces the required travel distance for any single particle by an order of magnitude, directly solving the latency problem inherent in prior art. Consequently, the display can achieve refresh rates necessary for persistence of vision (e.g., 30 Hz) without exceeding the physical speed limits of the particles or the modulators.

Additionally, the specific use of Bessel beams imparts a “self-healing” physical property to the optical tube, ensuring that the optical structure defining downstream traps remains intact even when upstream particles scatter light. This allows for the robust, simultaneous manipulation of particle chains, which was not previously achievable with Gaussian beam traps. Further, the cars provide a capture mechanism or “entry point” for getting particles into the tube. This would be useful, for instance, in a projection scenario where particles are projected through the light tubes and a mechanism is used to grab and push them along the tube.

A technical advantage of the incoherent array architecture is the integration of trapping and illumination into a single, safe, solid-state platform. By replacing coherent lasers with micro LED arrays, the system eliminates the safety hazards associated with collimated coherent radiation, rendering the device suitable for practical applications such as educational kits and consumer displays. Technically, the array structure provides a granular level of control unavailable in laser systems; specifically, the system can selectively activate different colored pixels (e.g., red, green, blue) at different spatial angles relative to the trapped particle. This capability allows the system to control the directionality of the scattered light, enabling “view-dependent” displays where different observers see different images from the same voxel. Thus, the invention does not merely automate a known trapping method but creates a new functional capability—directional scattering control—through the specific addressability of the illumination array.

Using the disclosed techniques, the above-described technology can be used to create scalable, sci-fi-style 3D displays for communication or advertising. By using the “elevator car” technique, where columns of particles are trapped and moved simultaneously within beams of light, the system can render complex volumetric images much faster than previous methods. Furthermore, using arrays of micro LEDs allows these displays to be “view-dependent.” This means a single floating image could display one visual to a person standing on the left and a completely different visual to a person on the right, enabling private data visualization in public spaces or multi-perspective entertainment experiences without special glasses.

In another example, because the above-described techniques enable optical trapping using safe, incoherent light sources like sunlight or standard LEDs (instead of dangerous lasers), it can be packaged into affordable educational kits. Students could use a “sun-powered” kit to trap and observe particles in mid-air using a simple lens setup outdoors, fostering “freedom of exploration” without the risk of eye damage. Specific product concepts include “glass umbrellas” that automatically refill the trap with particles, allowing kids to experiment with advanced physics safely and intuitively.

In another example, the above-described techniques applied to trapping particles can be adapted for “aerial additive manufacturing,” where materials are held and assembled in free space by light beams rather than being built layer-by-layer on a physical plate. This is useful for space applications; for example, a robot in orbit could blow a gas-filled bubble to create a controlled environment and then use sunlight-driven optical traps to organize floating components or “space junk” into useful tools or structures inside the bubble. This method eliminates the need for heavy mechanical gantries and allows for contactless assembly of delicate parts. One way to harness such sunlight is to make use of passive optics such as an adiabatic taper which can increase spatial coherence for trapping particles. Examples of such a taper can include a square acrylic rod pulled to a taper or the use of etched gratings to couple light into a waveguide.

As used herein, a “particle” refers to a small physical object—such as a droplet, a speck of soot, a nanodiamond, or a solid granule—that serves as the light-scattering element (or voxel) within the volumetric display. Unlike the transparent nanoscale beads typically utilized in conventional optical tweezers which are held at intensity maxima, the particles described in this invention can be opaque, are capable of being significantly larger (e.g., 100 microns), and are typically localized at regions of low light intensity (intensity minima) via photophoretic forces generated by the interaction between the light beam and the surrounding gas.

As used herein, “source” refers to any device, system, or natural phenomenon configured to generate or emit electromagnetic radiation utilized for optical trapping, manipulation, or illumination within the display system. This term encompasses both coherent light sources, such as traditional laser systems, and incoherent light sources. Specific examples of sources disclosed include solid-state arrays (such as micro-LEDs or VCSEL arrays), artificial broad-spectrum emitters (including incandescent bulbs, fluorescent lamps, halogen lights, mercury and sodium vapor lamps, neon lights, and arc lamps), and naturally occurring emitters (such as sunlight, starlight, firelight, and bioluminescent organisms). The source may be configured to produce radiation across various spectral ranges, including but not limited to visible light, infrared (IR), and ultraviolet (UV) wavelengths.

As used herein, “optical system” refers to an assembly of one or more optical components configured to shape, direct, modulate, or combine electromagnetic radiation to form specific beam intensity profiles or manipulate the position of such profiles in space. The term encompasses a broad range of elements including static refractive or diffractive components—such as axicons, lenses, prisms, beam splitters, and holographic optical elements (HOEs)—as well as dynamic or active modulation devices—such as spatial light modulators (SLMs), acousto-optic modulators, or dynamic phase masks.

As used herein, “beam” refers to a directed projection or spatial distribution of electromagnetic radiation possessing a defined intensity profile utilized for the confinement, manipulation, or illumination of particles. The term extends beyond simple ray paths to encompass complex, structured light fields—such as Bessel beams, pseudo-Bessel beams, and “frozen waves”—often created through the superposition or interference of multiple wavefronts, as well as Gaussian and Laguerre-Gaussian beams formed from illumination sources. A beam may be characterized by its ability to form “optical tubes” or volumetric regions containing intensity minima and maxima (described as “walls,” “floors,” and “ceilings”) that serve as “elevator cars” for trapping multiple particles simultaneously along an axis. The term applies effectively to radiation produced by both coherent sources, such as lasers, and incoherent sources, such as micro-LED arrays or sunlight, which are shaped by an optical system to form the requisite trapping regions.

As used herein, “localized” refers to the confinement, trapping, or spatial restriction of a particle within a specific, defined volumetric region of an electromagnetic beam. This term describes the state in which a particle is held at a targeted feature of the beam's intensity profile—most notably at an intensity minimum (a region of low light intensity) surrounded by regions of higher intensity (described as the “walls,” “floor,” and “ceiling” of an “elevator car”). This localization is achieved through optical forces, such as photophoretic repulsive forces, which push the particle into the trap site and prevent it from exiting the defined volume, thereby allowing the particle to be manipulated and moved with the optical structure.

As used herein, “intensity profile” refers to the spatial distribution of electromagnetic radiation magnitude along a defined axis of a beam, determining the specific locations where optical forces will confine matter. This profile is characterized by a structured variation of light and dark regions—specifically distinct intensity minima (regions of low light) and intensity maxima (regions of high light)—which function effectively as the “floors” and “ceilings” of optical “elevator cars.” This profile defines the trapping volumes where particles are localized and is capable of being dynamically modulated (e.g., by shifting the phase of interfering Bessel beams) to move these minima along the axis, thereby transporting the trapped particles either separately, one or some at a time, or in unison.

As used herein, “axis” refers to the longitudinal direction of propagation or the central centerline of the electromagnetic beam along which the intensity profile is structured. This term denotes the spatial path defining the length of the “optical tube” or “elevator shaft,” along which the periodic intensity minima (functioning as “elevator cars”) are distributed. This term may serve as the primary directional reference for the confinement, alignment, and simultaneous movement of the multiple particles within the volumetric display system.

As used herein, “volumetric region” refers to a distinct, three-dimensional subdivision of an electromagnetic beam configured to spatially confine a particle. Within the context of the claims and specification, these regions are frequently described as “elevator cars”—discrete pockets of low light intensity (intensity minima) encapsulated by high-intensity boundaries acting as “walls,” “floors,” and “ceilings.” These regions are arranged sequentially along the axis of the beam (like cars in a shaft), allowing multiple particles to be trapped in separate, non-overlapping volumes within a single “optical tube” and moved separately, some or one at a time, or in unison by modulating the beam's interference pattern.

As used herein, “separately” refers to the movement of multiple trapping regions (specifically intensity minima or “elevator cars”) along the axis of the beam such that at least one of the regions moves in a different direction or at a different speed/rate with respect to other regions. As used herein, “some or one at a time” refers to the movement of multiple trapping regions (specifically intensity minima or “elevator cars”) along the axis of the beam such that at least one of the regions is does not move, i.e. remains in the same position as other regions move along the axis.

As used herein, “in unison” refers to the simultaneous and synchronized movement of multiple trapping regions (specifically intensity minima or “elevator cars”) along the axis of the beam, such that the regions maintain their relative spatial separation and move with the same velocity and direction. This term describes the collective shifting of the beam's entire interference pattern—often achieved by modulating the phase of the optical components—which causes the first and second particles to travel together as if they were fixed points within a single moving rigid structure, rather than being steered independently.

As used herein, “optical element” refers to a discrete physical component or sub-assembly within an optical system configured to shape, direct, filter, phase-shift, or modulate electromagnetic radiation to achieve a specific beam structure or dynamic control. In the specific context of the claims and specification, the term is explicitly exemplified by axicons (conical lenses) used to generate the Bessel beams that form the “walls,” “floors,” and “ceilings” of the optical trapping regions. The term further encompasses holographic optical elements (HOEs) utilized to focus or direct incoherent light, as well as lenses, prisms, mirrors, and dynamic devices such as spatial light modulators (SLMs) capable of altering the phase of light rays to move the trapping regions separately, some or one at a time, or in unison.

As used herein, “Bessel beam” refers to a structured beam of electromagnetic radiation, often characterized as “non-diffracting” or “self-healing,” which possesses an intensity profile resembling a set of concentric rings or “nested tubes” extending along an axis. These beams may be generated using axicons (conical lenses) or spatial light modulators and serve as the structural “walls” of an “optical tube” or “elevator shaft” capable of laterally confining particles. The above-described techniques utilize the interference of multiple Bessel beams (often created by superimposing axicons with distinct apex angles) to form periodic intensity minima—functioning as the “floors” and “ceilings” of “elevator cars”—which allow multiple particles to be trapped and manipulated simultaneously along the beam's propagation path. A characteristic used in the system is the beam's self-healing nature, which ensures that light scattered by a first trapped particle does not destroy the trap structure for subsequent particles located further down the axis.

As used herein, “axicon” refers to a specialized optical element having a conical refracting surface—typically described as a “cone of glass” or a prism revolved around an axis—configured to transform a standard light beam into a Bessel beam or pseudo-Bessel beam characterized by a non-diffracting, ring-like intensity profile. Axicons can serve as the primary components of optical systems such as the “first optical system” recited in claim 1 responsible for generating the structural “walls” of the optical trapping tubes. The above-described techniques involve the superposition of multiple axicons (e.g., a first axicon and a second axicon with a slightly larger apex angle) to create an interference pattern that generates periodic intensity minima along the beam axis; these minima function as the “floors” and “ceilings” of the “elevator cars” necessary to trap and move multiple particles separately, some or one at a time, or in unison.

As used herein, “superposed” refers to the arrangement of optical elements, such as axicons, wherein the elements are aligned coaxially along a common optical path such that electromagnetic radiation passes through both elements sequentially or simultaneously to modify the wavefronts.

As used herein, “apex angle” refers to the geometric angle at the vertex or tip of the conical refracting surface of an axicon. This angle determines the degree to which light rays are refracted relative to the optical axis, thereby defining the cone angle of the resulting Bessel beam. The invention specifically relies on the superposition of a first axicon and a second axicon having distinct apex angles (e.g., the second being greater than the first). This difference in apex angles causes the wavefronts generated by each optical element to intersect and interfere, creating the periodic intensity variations (specifically the “floors” and “ceilings” of the “elevator cars”) along the beam axis necessary to trap and hold particles.

As used herein, “rays” refers to the constituent propagation paths or wavefront normals of the electromagnetic radiation which, when superimposed or interfered, generate the structured intensity profiles defining the optical traps. The term denotes the light components—such as those refracted by superposed axicons—whose relative phase is dynamically modulated (e.g., by a spatial light modulator) to shift the interference pattern along the axis. This modulation of the rays alters the position of the intensity minima (the “floors” and “ceilings” of the “elevator cars”), thereby causing the trapped particles to move separately, some or one at a time, or in unison.

As used herein, “phase” refers to the position of a point within the cycle of an electromagnetic waveform relative to a reference, determining how multiple waves interact through interference. This term relates to the relative synchronization of the light rays—such as those constituting interfering Bessel beams—which establishes the spatial structure of the beam's intensity profile (i.e., the location of the “floors” and “ceilings” of the optical traps). The above-described techniques rely on the dynamic modulation of this phase (typically via a spatial light modulator) to shift the constructive and destructive interference pattern along the axis. By continuously altering the phase, the system effectively translates the intensity minima (the “elevator cars”) along the beam path, causing the trapped particles to move without altering the physical arrangement of the optical elements.

As used herein, “illumination source” refers to a device or system configured to generate electromagnetic radiation, characterized in the claims as comprising an array of illumination elements—such as micro-light-emitting diodes (micro LEDs)—configured to produce incoherent illumination. Unlike traditional optical trapping systems that rely on expensive, coherent laser sources, the illumination source described in the invention utilizes solid-state arrays or broad-spectrum emitters (including LEDs, incandescent lamps, or even sunlight) to provide the optical power necessary to both localize particles within a trap (often at intensity minima) and illuminate them for display purposes. This configuration allows for the dynamic control of spatial, temporal, and spectral properties (color) of the light, enabling functions such as directional display and scanning traps without the safety hazards and mechanical complexity of laser-based systems.

As used herein, “array of illumination elements” refers to a structured, solid-state grouping of multiple discrete light-emitting components configured to generate electromagnetic radiation, specifically characterized in the claims as producing incoherent illumination. These arrays—exemplified primarily by micro-light-emitting diodes (micro LEDs), but also encompassing quantum dot arrays and VCSEL arrays—are utilized to overcome the power and safety limitations of single laser sources by aggregating the output of thousands of small pixels (e.g., 1 to 10 microns in size) to achieve the high intensity required for optical trapping. Unlike traditional setups, these arrays enable “many-to-one” imaging, where individual emitters can be dynamically addressed to control the color, shape, and position of the optical trap, as well as the directionality of the light scattered by the trapped particle.

As used herein, “incoherent illumination” refers to electromagnetic radiation generated by sources that possess lower spatial or temporal coherence than traditional laser systems, often characterized by broad spectral bandwidths or extended emission areas. Within the context of the claims and specification, the term encompasses light produced by solid-state arrays—such as micro-light-emitting diodes (micro LEDs) and VCSEL arrays—as well as artificial broad-spectrum emitters (including incandescent, fluorescent, halogen, neon, and arc lamps) and naturally occurring environmental sources such as sunlight, starlight, firelight, and bioluminescent organisms. This illumination is utilized to form optical traps (e.g., intensity minima) and visible displays through imaging or scanning techniques that do not rely on the precise interference patterns required by coherent laser sources, thereby mitigating safety hazards and reducing system complexity.

As used herein, “region” refers to a specific, spatially defined volume within an electromagnetic beam or field where optical forces are sufficient to localize, confine, or trap a particle. In the context of the claims and specification, the term encompasses distinct “volumetric regions”—frequently described as “elevator cars”—which function as discrete pockets of intensity minima (dark regions) bounded by intensity maxima (light regions such as “floors,” “ceilings,” and “walls”) along the beam's axis. In aspects utilizing incoherent sources like micro LED arrays, the term may specifically denote the area surrounding the foci of combined beams where a particle is held. These regions are capable of being dynamically moved or scanned to transport the confined particle through space.

As used herein, “foci” refers to the specific spatial points of convergence where electromagnetic radiation from the illumination elements (such as micro LEDs) is concentrated by the optical system to achieve high intensity. These focal points serve as the structural anchors for the optical trap; they may be superimposed to create a single high-intensity spot for illumination, or spatially arranged around a target zone to form a “minima trap” (a dark volumetric region surrounded by bright “hot spots”) that confines the particle via repulsive forces.

As used herein, “region about foci” refers to a specific volumetric space located in the immediate vicinity of the convergence points of multiple electromagnetic beams, where the spatial arrangement of high-intensity focal spots defines the boundaries of an optical trap. Within the context of the claims and specification, this term describes a configuration—frequently identified as a “minima trap”—where the focal spots of the incoherent illumination elements (such as micro LEDs) are imaged to surround a central target zone rather than overlapping directly upon it. This geometry creates a “cage” of light composed of high-intensity barriers (the foci) that encircle a central pocket of low light intensity (the region), thereby confining a particle within the dark center via repulsive optical forces such as photophoresis.

As used herein, “holographic optical element” refers to a diffractive optical component utilized to shape, direct, or combine electromagnetic radiation—specifically from an incoherent source such as an array of illumination element—to form the intensity profiles or focal points necessary for optical trapping. These elements are frequently modeled as or function equivalently to superimposed lenses and prisms, capable of imaging multiple discrete light sources (e.g., micro LEDs) into a single, high-intensity trap volume. A distinctive feature emphasized in the claims is the element's dispersive property, which allows the system to move a localized particle in space simply by changing the color (wavelength) of the illumination incident upon the holographic optical element, thereby enabling steering without physical movement of the optics. The term encompasses both static devices (such as hard copy holograms) and dynamic modulation surfaces.

As used herein, “micro LEDs” (or micro-light-emitting diodes) refers to microscopic solid-state light-emitting components-typically having linear dimensions in the range of approximately 1 to 10 microns-arranged in high-density arrays to produce incoherent illumination. Within the context of the claims and specification, these devices are distinguished from traditional LEDs (often ~100 microns) by their ability to be focused into extremely small, high-intensity spots comparable to laser foci, thereby allowing them to generate sufficient optical pressure to trap particles. The above-described techniques use these arrays to achieve “many-to-one” imaging, where light from thousands of discrete micro LEDs is superimposed (e.g., via lenses or holographic optical elements) to form a single high-power trap or illumination volume, enabling multicolor, directional displays without the safety hazards or coherence artifacts of laser-based systems.

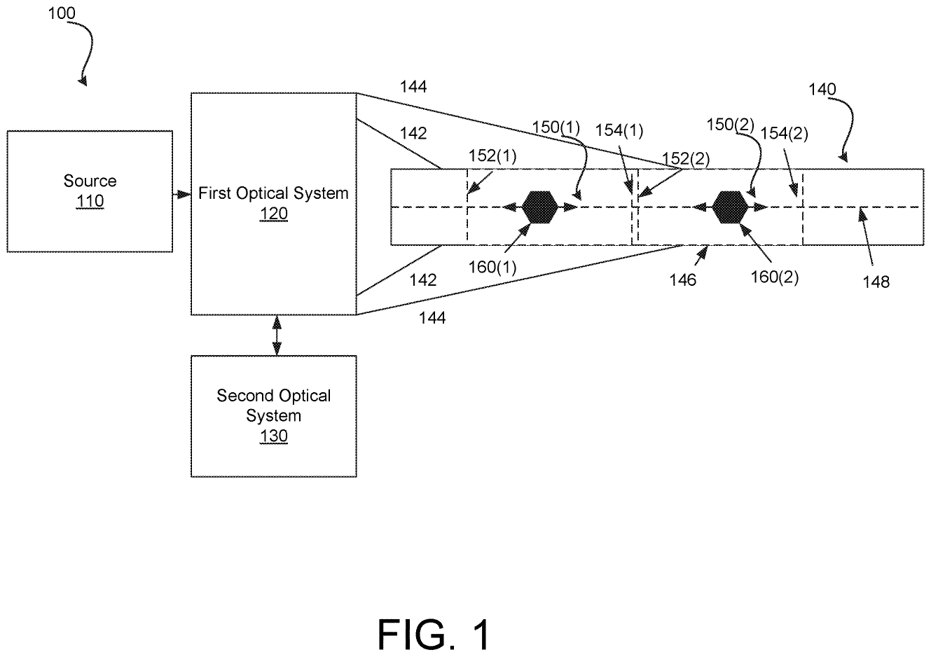

FIG. 1 is a diagram illustrating an example three-dimensional raster imaging system 100 using an optical tube 140 that traps multiple particles 160(1) and 160(2). This example is not intended to be limiting and is presented for ease of discussion. For example, there can be any number of particles in the optical tube 140.

The system 100 generally comprises a source 110, a first optical system 120, and a second optical system 130. The source 110 is configured to produce electromagnetic radiation, which serves as the raw input for creating the optical traps described herein. While the source 110 may include lasers in some embodiments to generate coherent light, other embodiments contemplate the use of incoherent sources such as arrays of micro-LEDs.

The electromagnetic radiation produced by the source 110 is directed toward the first optical system 120. This first optical system 120 is configured to shape and form the radiation into a structured beam or set of beams that propagate along an axis 148. Specifically, the first optical system 120 transforms the radiation into an optical tube 140. This optical tube 140 is defined by a wall 146, which constitutes a region of high intensity that acts as a lateral barrier, confining matter within the interior of the tube along the propagation path.

Within the optical tube 140, the system creates specific volumetric regions capable of trapping matter. As illustrated in FIG. 1, the optical tube 140 contains a plurality of these regions, referred to herein as elevator cars, including a first elevator car 150(1) and a second elevator car 150(2). These elevator cars are distinct, separate volumes located sequentially along the axis 148. They effectively function as “compartments” of low light intensity (intensity minima) situated within the high-intensity boundaries of the beam structure.

The structural boundaries of these elevator cars are defined by intensity maxima generated by the interference of the beams. Specifically, the first elevator car 150(1) is bounded axially by a floor 152(1) and a ceiling 154(1). Similarly, the second elevator car 150(2), which is located further along the axis 148, is bounded by a floor 152(2) and a ceiling 154(2). These floors and ceilings represent regions of high optical intensity that prevent trapped matter from escaping axially along the tube.

The optical structure is formed through the interaction of a first beam 142 and a second beam 144. In some implementations, these beams are Bessel beams or pseudo-Bessel beams generated by optical elements such as axicons within the first optical system 120. For example, the superposition of a first axicon and a second axicon having a slightly different apex angle causes the wavefronts of the first beam 142 and the second beam 144 to interfere. This interference creates the periodic pattern of bright regions (floors and ceilings) and dark regions (the interior of the cars) along the axis 148.

Situated within these elevator cars are the objects to be manipulated. FIG. 1 depicts a first particle 160(1) localized within the first elevator car 150(1) and a second particle 160(2) localized within the second elevator car 150(2). The particles are trapped at the intensity minima located between the respective floors and ceilings of their cars. The system uses repulsive forces, such as photophoretic forces, to push the particles away from the high-intensity walls 146, floors 152, and ceilings 154, thereby holding them suspended in the air within the trap volume.

A feature of the system 100 is the ability to manipulate these particles simultaneously. The second optical system 130 is operably coupled to the beam path and is configured to control the position of the elevator cars along the axis 148. By altering the properties of the light—specifically by changing the phase of the rays constituting the first beam 142 or the second beam 144—the second optical system 130 shifts the interference pattern. This phase modulation effectively translates the positions of the intensity minima and maxima along the beam path.

As the interference pattern shifts, the first elevator car 150(1) and the second elevator car 150(2) move along the axis 148. Because the particles are confined within these cars, the first particle 160(1) and the second particle 160(2) are configured to move along with them. The arrangement ensures that the particles move “in unison,” maintaining their relative spacing as they travel up or down the optical tube 140. This arrangement, however, is only for illustrative purposes and it is possible that the particles can move separately or one at a time. This allows the system to treat the multiple particles as a single rigid chain moving through space.

The use of Bessel beams for the first beam 142 and second beam 144 provides a “self-healing” property to the optical tube 140. This ensures that light scattered by the first particle 160(1) does not reduce the structural integrity of the second elevator car 150(2) downstream. Consequently, the wall 146 and the trapping forces remain intact for the second particle 160(2) despite the presence of the first particle 160(1) closer to the source 110.

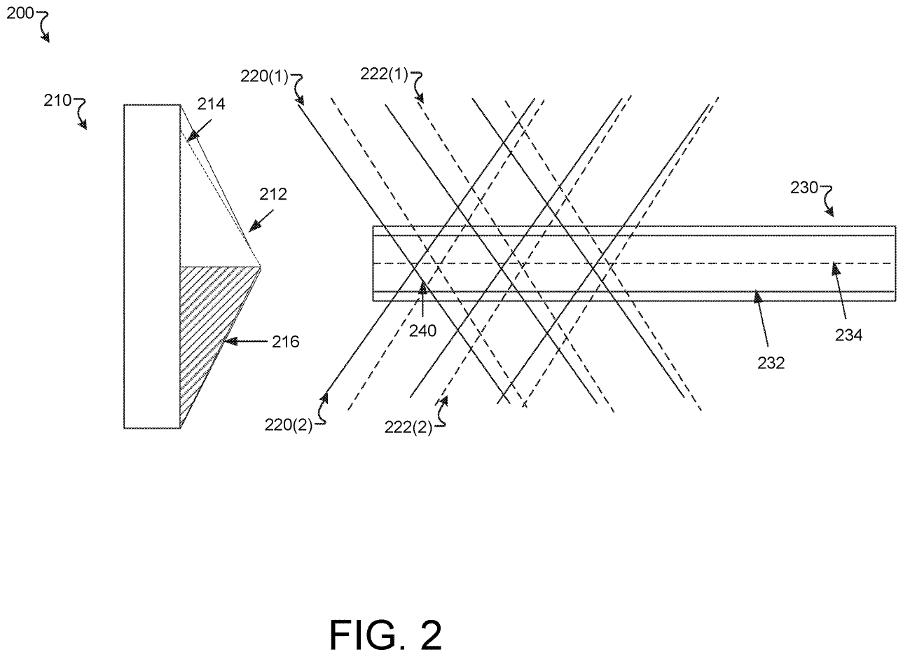

In some implementations, the optical tubes and beams described herein are not constrained to a fixed, parallel orientation along a single longitudinal axis (z). Rather, the beams can be directed in any direction within the three-dimensional display volume to increase volumetric resolution or to address specific spatial geometries. For example, as illustrated in the description of FIG. 2 in the source materials, the optical system may be configured to “fan out” the beams in many directions, effectively radiating light outward like a sphere rather than projecting a simple parallel column. This directional diversity allows the system to trap and manipulate particles along non-parallel axes, enabling the formation of complex, interlocking particle trajectories that can fill voxel gaps left by parallel raster scanning.

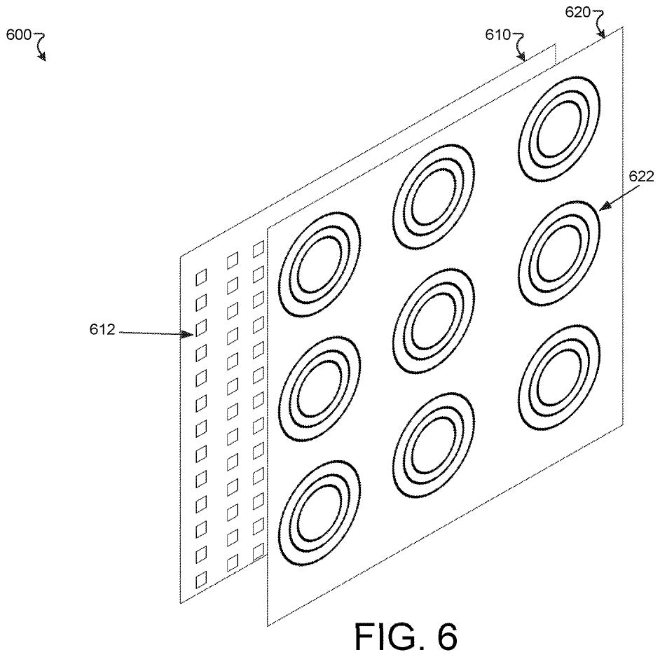

Furthermore, the system is configured to dynamically move or tilt the beam axes to scale the effective resolution of the display. By utilizing the “many-to-one” imaging capabilities of the source array (as detailed in FIG. 6), the system can electronically steer the optical tubes by selecting different subsets of illumination elements (e.g., micro LEDs) or by modulating a holographic optical element. This allows the system to trade off optical power for resolution; for instance, the system may rapidly shift the angle of an optical tube by a fraction of a degree to access interstitial voxel coordinates that lie between the “elevator cars” of a previous scan. This sub-pixel shifting or “dithering” of the beam direction effectively increases the addressable resolution of the display without requiring physically smaller particles or faster modulation rates. Additionally, multi-axis tube sets can be generated simultaneously, where a first set of tubes traps particles along a vertical axis and a second set traps particles along a horizontal or diagonal axis, allowing for the creation of grid-like particle matrices that improve the structural rigidity and visual density of the floating image.

In some implementations, the beams 142 and 144 are configured to accomplish trapping, rastering, and illumination of the particles 160(1) and 160(2) without relying on mechanical scanning components. For example, the optical tube 140 may be superimposed onto or directed through a projected image volume—such as an axial hologram or highly directional light field—that is otherwise invisible to an observer because the light is not directed toward the observer's eye. As the particles 160(1) and 160(2) traverse the axis 148 driven by the moving “elevator cars,” they act as dynamic scattering centers that intercept the invisible image light and change its direction, thereby rendering the image visible. This scattering interaction can be controlled such that the image is visible only to users in certain positions or viewing angles, enabling view-dependent or privacy displays. Furthermore, the optical tube 140 is not constrained to a fixed orientation; the beams can be directed in any direction or fanned out to increase the volumetric resolution or to address specific spatial coordinates within the display volume.

In some implementations, the system functions as a programmable “volume diffuser” where the trapped particles serve as physical decoders for invisible image fields. In this configuration, the illumination source (e.g., an array of microLEDs or a holographic projector) projects a “latent” image volume into the trapping zone. This latent image may consist of highly collimated light or an axial hologram where the optical information is encoded along propagation vectors that do not naturally intersect the viewer's eye (e.g., light traveling parallel to the viewer's line of sight or concentrated in narrow angular lobes). Consequently, this projected image volume remains invisible to an observer looking at the display from the side. The trapped particles, driven by the optical tubes, act as dynamic scattering centers that “decode” this information. As a particle traverses the latent image volume, it intercepts the directional rays and scatters them radially, rendering the specific voxel visible only at the precise coordinate where the particle intersects the beam.

Furthermore, this scattering interaction enables multi-user spatial encoding, allowing the system to create view-dependent displays where different observers perceive different images simultaneously from the same display volume. By utilizing the high angular resolution of the source array (as described in FIG. 6), the system can encode distinct image data into specific angular emission lobes incident on the particle. For example, the system may direct a green light ray to strike the particle from a trajectory calculated to scatter toward a first viewing zone (“pupil box”) located at a 45-degree angle, while simultaneously directing a red light ray to strike the same particle from a trajectory calculated to scatter toward a second viewing zone at a −45-degree angle. From the perspective of the first user, the particle appears green; from the perspective of the second user, the same particle appears red. This effectively allows the particle to function as an angle-dependent mixing node, decoding separate video streams for separate users based on their physical position in the room, thereby enabling privacy modes or multi-perspective 3D rendering.

In a specific embodiment utilizing axial holography, the illumination system projects a hologram along the axis of the optical tubes. While the holographic reconstruction is formed along the beam path, it is typically not visible to off-axis observers. The trapped particles, moving within the “elevator cars,” continuously slice through this reconstruction. As they do so, they scatter the coherent light of the hologram, effectively converting the longitudinal intensity distribution of the hologram into a transverse visible image. This ensures that the volumetric image remains pristine and viewable from lateral positions, using the particles not merely as light emitters, but as a controllable scattering medium that interfaces between the coherent projection and the human eye.

In some implementations, the generated beams are configured to simultaneously accomplish trapping, rastering, and illumination without scanning. As used herein, “without scanning” refers to the generation of volumetric imagery without the requirement of mechanically or optically steering a single focal point or trap continuously through every voxel coordinate of the display volume (a process known as single-particle vector scanning). Unlike conventional optical tweezers that must move a single particle rapidly along a complex path to trace a shape (similar to drawing with a sparkler), the present system utilizes optical structures—such as the optical tubes 140 or the “many-to-one” imaged arrays—that provide persistent lateral confinement (x, y) without physical beam movement.

Instead of per-voxel beam steering, the system achieves “rastering” through the simultaneous, rigid-body transport of multiple particles along the axis (z) using the “elevator car” mechanism. The lateral position of the beam remains fixed (or, in the case of microLED arrays, is switched electronically in a solid-state manner), while the axial movement is handled by phase modulation or pixel addressing. Furthermore, illumination is accomplished integrally without a separate scanning process; this occurs either because the high-intensity “walls” of the trap themselves constitute the visible light (e.g., using colored microLEDs to form the trap structure) or because the particles are transported through a static projected image volume. This architecture eliminates the latency and mechanical complexity associated with vector scanning, allowing the beams to function as a static scaffold through which matter flows to generate the image.

This configuration serves as the foundation for a volumetric display. By moving the particles 160(1) and 160(2) along the axis 148 while illuminating them, the system 100 can trace out images in space. The use of multiple particles decreases the distance any single particle must travel to refresh an image, thereby overcoming the speed limitations of spatial light modulators and allowing for scalable, high-speed volumetric imaging.

FIG. 2 is a diagram illustrating an example raster imaging system 200 that uses superposed axicons to produce beams that form the optical tubes that trap particles.

FIG. 2 provides a schematic representation of the optical mechanism used to generate the structured beams and trapping regions within the system 200. In this configuration is the first optical system 210, which serves as a primary beam-shaping assembly. This system is configured to transform the initial electromagnetic radiation into a complex interference pattern capable of confining particles. The first optical system 210 typically comprises a set of diffractive or refractive elements configured to shape the incoming light into Bessel beams or pseudo-Bessel beams.

The optical assembly illustrated in FIG. 2 includes a first optical element, specifically a first axicon 212, and a second optical element, specifically a second axicon 214. As described above, an axicon is a conical optical element that can create a non-diffracting beam by refracting light toward an optical axis. In some implementations and as shown in FIG. 2, the first axicon 212 and the second axicon 214 are superimposed or aligned along a common path to manipulate the incoming radiation simultaneously.

The operation of the first axicon 212 results in the emission of a specific set of wavefronts. These are depicted in the figure as wavefronts 220(1) and 220(2). These wavefronts represent the propagation of light rays refracted by the conical surface of the first axicon 212. Because of the axicon's geometry, these wavefronts propagate inward toward the central axis, creating a conical overlap region where the beam intensity begins to structure itself into the requisite “tube” form.

Simultaneously, the second axicon 214 emits a distinct set of wavefronts, illustrated as wavefronts 222(1) and 222(2). A critical feature of this arrangement, as noted in the sources, is that the second axicon 214 typically possesses a different apex angle than the first axicon 212 (e.g., a slightly greater apex angle). This difference in geometric angularity causes the wavefronts 222(1) and 222(2) to intersect the wavefronts 220(1) and 220(2) at specific angles, leading to a controlled interference pattern along the propagation path.

The interference between the wavefronts 220 produced by the first axicon 212 and the wavefronts 222 produced by the second axicon 214 generates the optical tube 230. This optical tube 230 is not merely a cylinder of uniform light but is a highly structured field often described as a nested set of tubes. The innermost layers of this interference pattern form the high-intensity boundaries that define the “elevator shaft,” effectively creating the walls necessary for lateral confinement of particles.

Within the optical tube 230, the interference pattern manifests as a series of intensity maxima and minima distributed along the axis 234. FIG. 2 highlights a specific volumetric region 240, which corresponds to one of these intensity minima. This region functions as an “elevator car” where a particle can be trapped. The high-intensity regions resulting from the constructive interference of the wavefronts act as the “floor” and “ceiling” of this volumetric region 240, preventing the particle from moving axially, while the “walls” prevent lateral escape.

Bounding the optical tube 230 laterally is the outer wall 232. In the context of Bessel beams, this outer wall 232 corresponds to a secondary lobe or a higher-order ring of the beam's intensity profile. While the primary trapping occurs within the central regions or the innermost wall, these secondary lobes are characteristic of the non-diffracting nature of Bessel beams, helping to maintain the structural integrity of the central trap over long propagation distances—a property referred to as “self-healing.” The system is designed not only to trap particles but to move them. FIG. 2 identifies a region 216, which represents a portion of the first axicon 212 and second axicon 214 where the phase is changed. As explained in the sources, dynamic movement is achieved by altering the phase relationship between the interfering rays. This phase modulation is typically executed by a spatial light modulator (SLM) or similar dynamic optical element that alters the effective path length or delay of specific portions of the wavefronts.

When the phase is changed at region 216, the interference pattern creating the optical tube 230 shifts along the axis 234. Specifically, the constructive and destructive interference nodes—the floors and ceilings—translate forward or backward along the axis 234 without altering the relative spacing between them. Consequently, the volumetric region 240 moves along the axis 234, carrying the trapped particle with it in unison with any other particles trapped in adjacent regions. In some implementations, however, the volumetric region 240 carries with trapped particle separately or one at a time with the other particles.

FIG. 2 illustrates the physical mechanism by which optical elements (axicons 212 and 214) and dynamic phase control (region 216) cooperate to form a movable trap. The intersecting wavefronts 220 and 222 create a robust optical tube 230 centered on the axis 234, containing a volumetric region 240 shielded by an outer wall 232. This configuration enables the scalable, “elevator car” style manipulation of particles required for the volumetric display technology.

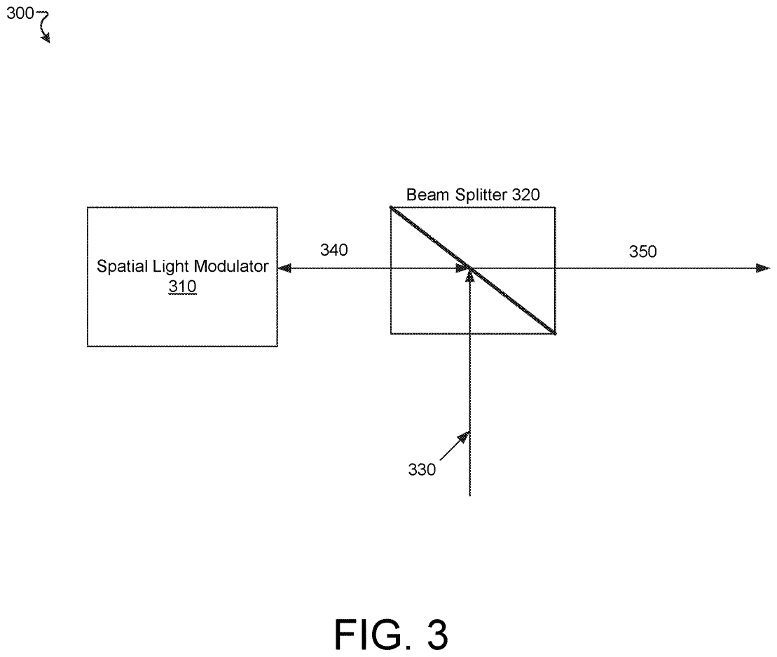

FIG. 3 is a diagram illustrating an example spatial light modulator 310 for beam formation and phase change.

FIG. 3 illustrates a sub-system 300 configured to modulate the electromagnetic radiation used to form the optical traps. This system is integral to the “second optical system” described in the claims, which is responsible for moving the “elevator cars” or volumetric regions along the axis of the beam. The components depicted include a spatial light modulator 310 and a beam splitter 320, which cooperate to alter the properties of the light before it interferes to form the trapping potential.

The process begins with a ray of illumination 330 originating from the source (such as the illumination source 110 described in FIG. 1). This ray 330 enters the sub-system and is incident upon the beam splitter 320. The beam splitter 320 is positioned to direct the incoming radiation toward the modulation device. Specifically, the beam splitter 320 reflects the incoming ray 330, redirecting it toward the active surface of the spatial light modulator 310.

The reflected light travels as a ray 340 from the beam splitter 320 to the spatial light modulator 310. The spatial light modulator 310 is an optical element capable of altering the phase of the incident wavefronts. The spatial light modulator 310 is, in some implementations, a device such as a liquid crystal on silicon (LCOS) display or a similar phase-modulating array. As described above, this device effectively changes the “bright and dark concentric circles” of the beam structure (such as a Bessel beam) by introducing a controllable phase delay to the light striking its surface. This modulation is what allows the system to shift the interference pattern without moving the physical optical components.

After interacting with the spatial light modulator 310, the light is reflected back toward the beam splitter 320. This returning light is depicted as a phase-changed ray 350. Because its phase has been altered relative to the other beams in the system (e.g., the beam from a static axicon), this ray 350, when output from the beam splitter 320, interferes constructively and destructively at new locations along the propagation axis. This shift in interference causes the intensity minima—the floors and ceilings of the elevator cars—to translate along the optical tube, thereby moving any trapped particles in unison. In some implementations, however, the shift in interference is such that the trapped particles are moved separately or some or one at a time.

In some implementations, the system is configured to move a first particle and a second particle independently within the same optical tube, rather than constraining them to move in unison. To achieve this, the optical system generates a composite beam structure comprising two separate interference patterns superposed along the same propagation axis. The first interference pattern defines a first set of intensity minima (elevator cars) controlled by a first phase function, while the second interference pattern defines a second set of intensity minima controlled by a distinct second phase function. By independently modulating these patterns, the system can translate the first minimum in a first direction (e.g., upward) while simultaneously translating the second minimum in a second direction (e.g., downward) or holding it stationary, effectively creating two independent “tracks” within the same physical shaft.

This independent control may be realized through wavelength multiplexing, where the first interference pattern is generated using a first wavelength of electromagnetic radiation and the second interference pattern is generated using a second, distinct wavelength. As described in the disclosure regarding spectral combining and multicolor beams, the optical system (which may include dispersive holographic optical elements or prisms) maps these distinct wavelengths to independent spatial modulators or diffractive structures. Consequently, the “red” floors and ceilings trapping the first particle can be phase-shifted independently of the “blue” floors and ceilings trapping the second particle, allowing the mechanical state of the particles to be addressed via spectral channels.

Alternatively, or in conjunction with wavelength methods, the second optical system may utilize a segmented phase mask on a spatial light modulator (SLM). In this configuration, the active surface of the SLM is logically or physically divided into multiple segments, where a first segment creates the wavefronts responsible for the first particle's trap and a second segment creates the wavefronts for the second particle's trap. By calculating the hologram required to generate arbitrary “light and dark regions” along the axis, the system can dynamically update the phase mask segments to shuttle individual particles between different axial positions (“layers”) without disrupting the global stability of the optical tube.

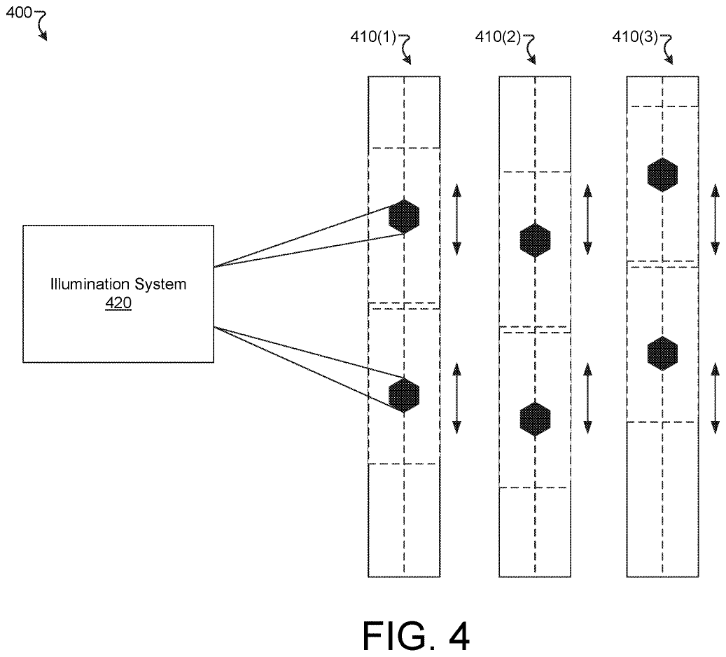

FIG. 4 is a diagram illustrating an example array of optical tubes with an illumination system 420 in a system 400 for generating images.

FIG. 4 illustrates a volumetric display system 400 configured to generate visible images through the interaction of trapped particles and an illumination field. The system is characterized by the use of an array of optical tubes, specifically designated as a first optical tube 410(1), a second optical tube 410(2), and a third optical tube 410(3). These tubes are arranged in parallel or a specific spatial configuration to define the display volume. Each optical tube functions similarly to the single “elevator shaft” described in previous figures, capable of confining and transporting multiple particles along its longitudinal axis using the “elevator car” trapping mechanism. The arrangement shown in FIG. 4 is for illustration purposes only and is not intended to be limiting and there may be more than or less than three optical tubes in the system 400.

The system 400 also includes an illumination system 420. This illumination system 420 is configured to project light-often described as an “image volume” or a field of visible radiation-across the path of the optical tubes. Unlike the trapping beams, which may be invisible (e.g., infrared) and are primarily responsible for the physical manipulation of the particles, the illumination system 420 provides the light necessary for the visual display. The illumination may comprise multiple colors and can be directed from various angles to ensure that the resulting image is visible to observers from different perspectives.

The arrangement depicted in FIG. 4 uses synchronized movement of particles within the optical tubes 410(1), 410(2), and 410(3) into and out of the light projected by the illumination system 420. As particles are moved along their respective axes (e.g., driven by the phase-shifting “elevator” mechanism), they enter the region illuminated by the system 420. Upon entering this region, the particles scatter the incident light, effectively becoming visible voxels in three-dimensional space. By coordinating the position of the particles with the modulation of the illumination source, the system can trace out complex 3D shapes or volumetric images.

In some implementations, the system 400 is configured to enable random access to specific spatial regions, depths, and colors within the volumetric display, exceeding the capabilities of simple raster scanning. The array of optical tubes 410(1)-410(3) operates in conjunction with the illumination system 420 to allow for granular control over individual voxels. Unlike implementations where all “elevator cars” must move in unison, this configuration supports complex beam superpositions—such as competing “push-pull” forces or independent modulation zones—that allow two particles within the same optical tube to behave independently. For instance, a first particle within the optical tube 410(1) can be driven upward while a second particle in the same tube simultaneously moves downward or remains stationary. This intra-tube independence allows the system to randomly access and refresh any point in the display volume without waiting for a full scan cycle.

This independent mechanical control can translate to advanced optical capabilities, specifically independent scattering and layer visibility. Because the system can precisely position particles relative to the illumination field 420, it can control the color and direction of scattered light based on the individual particle's depth and orientation within the tube. In layered imaging applications, the system can selectively move particles into specific illumination zones (image volumes) to render one depth layer visible while holding other particles in dark zones to keep a second layer invisible. This functionality allows for “view-dependent” displays where the directionality of the scatter is manipulated, effectively ensuring that light from specific layers reaches the viewer's eye with the correct clarity and color, or even allowing different viewers to see different images simultaneously based on their viewing angle.

Furthermore, the beams defining the optical structure may be capable of performing multiple functions independently. In some implementations, the functions are performed simultaneously. The high-intensity regions forming the “floors” and “ceilings” of the trap may not merely confine the particle; they can also serve as the illumination source. For example, an optical tube constructed of green light can trap a particle while naturally scattering green light to the viewer. Alternatively, the system can synthesize colors; a purple trapping region (floor/ceiling pair) could be superimposed within a green tube to provide discrete purple illumination points distinct from the tube's primary color. In some implementations, this multifunctionality extends to aerial additive manufacturing, where the optical tubes serve as a reaction vessel. In such an implementation, two resin particles could be trapped and manipulated within the same tube using invisible infrared beams (which hold but do not cure the material) and then brought together into specific ultraviolet (UV) light regions to instantly cure and bond them in mid-air.

An advantage of this array configuration includes the ability to control particle movement independently within each tube. The particles in optical tube 410(1) can move independently in direction and speed relative to those in optical tube 410(2) or 410(3). This independence allows for the creation of dynamic, layered image volumes where different parts of a 3D scene can be refreshed or animated simultaneously. Furthermore, the illumination system 420 can be configured to pass multiple colors through the image volume, allowing the scattering particles to reproduce full-color images rather than monochromatic structures.

In some implementations, the system is configured to generate a plurality of distinct beams that intersect at specific geometric coordinates to create simultaneous, independent control of the particle's physical state and its visual appearance. Rather than relying on a single beam to perform all functions, the optical system defines a “computational voxel” at the precise volumetric intersection of a trapping beam and an illumination beam.

In the configuration of intersection geometry and logical gating, the trapping beam (e.g., a static Bessel beam or optical tube generated by a first subset of the array) defines the spatial coordinate (x, y, z) of the voxel, effectively holding the particle in place. Simultaneously, an illumination beam (e.g., a focused spot generated by a second, independently addressable subset of the array) is directed to intersect the trapping beam at an oblique or orthogonal angle. This intersection geometry acts as a physical logic gate; the voxel is rendered “active” only within the specific volume where the illumination beam overlaps with the trapped particle. This allows for independent per-voxel control, where the trapping beam maintains the structural integrity of the display grid (keeping particles aligned) while the illumination beam is modulated at high speeds to define color and brightness without perturbing the particle's position.

For spectral and functional independence, to further decouple these functions, the intersecting beams may utilize different regions of the electromagnetic spectrum. For example, as illustrated in the source materials regarding FIG. 6, the system may utilize an “invisible” trapping beam (e.g., Infrared or IR) to form the “walls” of the optical trap. Because the particle is trapped by the IR beam but illuminated by a separate visible beam (e.g., Red, Green, or Blue) intersecting the trap, the functions are spectrally isolated. This allows the system to increase the “stiffness” or intensity of the trap dynamically to secure a particle during rapid movement without altering the brightness of the visible pixel perceived by the viewer. Conversely, the illumination can be strobed or color-shifted for display purposes without affecting the photophoretic forces holding the particle.

For force vectoring via beam intersection, the intersection of independent beams allows for complex vector manipulation within the voxel. As described in the context of VCSEL and micro LED hybrid arrays, a static vertical tube may intersect with a dynamic horizontal or angled “push” beam. By controlling the intensity and angle of the intersecting “push” beam, the system can apply a specific force vector to the particle—driving it up, down, or laterally within the trap—independent of the confinement forces provided by the primary tube. This enables a “rail-and-engine” architecture where the optical tube serves as the passive track and the intersecting beams serve as the active propulsion and coloring agents, all operating simultaneously on the same particle.

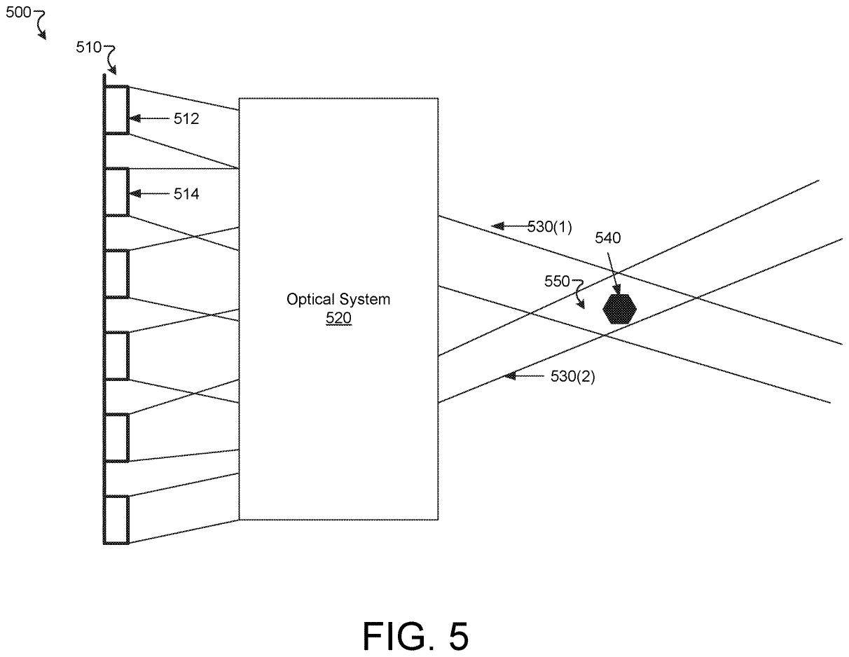

FIG. 5 is a diagram illustrating an example system 500 for generating an optical trap using incoherent illumination.

FIG. 5 illustrates a system 500 configured to trap and manipulate particles utilizing incoherent illumination. In contrast to systems that use coherent laser sources to generate interference-based Bessel beams, system 500 employs a source designed to reduce cost, complexity, and safety hazards. The core of this assembly is the incoherent illumination system 510, which serves as the primary generator of electromagnetic radiation for the device. This system is typically comprised of a high-density array of illumination elements, such as micro-light-emitting diodes (micro LEDs), VCSEL arrays, or quantum dot arrays, which are capable of producing high-power optical output without the high spatial or temporal coherence associated with lasers.

The incoherent illumination system 510 is shown comprising discrete sub-components, identified as a first incoherent illumination element 512 and a second incoherent illumination element 514. In a practical application, these elements represent individual pixels or clusters of pixels within the larger array. Because the source is incoherent, the system does not rely on the precise phase relationships required for standard interferometry; instead, it relies on the cumulative intensity and geometric arrangement of light emitted by these independent elements. This configuration allows for “many-to-one” imaging, where the output from widely separated elements (512 and 514) can be directed toward a single target zone.

In some implementations, a scanning trap using a temporal method may be used for imaging. The temporal method functions by using a single, high-intensity focal spot to “paint” the physical boundaries of an optical trap. Instead of simultaneously projecting all “walls” of a cage (as is done in the spatial method using Bessel beams or arrays), this method moves a focal spot around the perimeter of the target particle so rapidly that the particle experiences a continuous barrier. The physical principle behind this method relies on the difference between the speed of the light modulation and the relaxation time (movement dynamics) of the particle. A mechanism may involve the focal spot tracing the cross-section of the trap geometry (e.g., drawing a circle around the particle). The scanning speed is faster than the time it takes for the particle to react or move. Consequently, the particle effectively “feels” a solid wall of repulsive force, similar to how a fast-moving sparkler appears as a solid line to the human eye due to persistence of vision. This scanning may be accomplished using an acoustic-optic modulator (AOM), a micro LED strobe/switch, and/or a galvanometer.

Light emitted by the illumination elements is processed by an optical system 520.

This optical system is disposed in the path of the radiation and is configured to shape, focus, and direct the incoherent light. In various embodiments, the optical system 520 may include holographic optical elements (HOEs), lenses, or prisms designed to map the specific spatial output of the array elements to precise locations in the trapping volume. The optical system 520 acts as the bridge between the planar array of the source and the three-dimensional volumetric display space, effectively converting the 2D pattern of active micro LEDs into 3D optical potentials.

The optical system 520 transforms the radiation from the first incoherent illumination element 512 into a first beam 530(1). Additionally, it transforms the radiation from the second incoherent illumination element 514 into a second beam 530(2). These beams propagate away from the optical system 520 toward a target location. Because the source elements 512 and 514 are spatially distinct, the resulting beams 530(1) and 530(2) approach the target from different angles or trajectories. This geometric convergence is used for creating optical forces to confine a particle without using the self-interference of a single coherent beam.

The beams 530(1) and 530(2) are directed to converge at specific focal points. FIG. 5 depicts a volumetric region 550 which is located in the vicinity of these foci. In one configuration described as a “minima trap,” the optical system 520 images the beams such that their high-intensity focal spots surround the volumetric region 550 rather than overlapping directly on top of it. This creates a “cage” of light where the central region 550 is an intensity minimum (dark pocket) surrounded by high-intensity barriers (hot spots) formed by the beams.

Localized within this volumetric region 550 is a particle 540. The particle 540 is confined by the repulsive optical forces exerted by the beams 530(1) and 530(2). For example, if the particle moves toward the first beam 530(1), the photophoretic forces generated by the high-intensity light push it back toward the dark center of the region 550. This arrangement allows the system to trap and hold the particle 540 suspended in space. The use of arrays allows this trap to be robust; if the particle 540 scatters light from one beam, the other beams maintain the trap structure, providing a form of redundancy similar to the “self-healing” properties of Bessel beams but achieved through incoherent superposition.

The system 500 enables dynamic manipulation of the particle 540 by modulating the output of the incoherent illumination system 510. By turning specific illumination elements (like 512 or 514) on or off, or by changing their brightness, the position of the foci and the resulting volumetric region 550 can be shifted in space. This effectively scans the trap, dragging the particle 540 along with it. Furthermore, because the elements 512 and 514 can be different colors (e.g., Red, Green, Blue), the system can simultaneously trap the particle and illuminate it with specific wavelengths to create a colored voxel for display purposes.

The configuration shown in FIG. 5 addresses scalability limitations of conventional techniques. By replacing expensive and dangerous laser systems with solid-state micro LED arrays, the system 500 can be manufactured at a fraction of the cost while improving safety for users (as incoherent light is less hazardous to the eye than coherent laser radiation). This approach allows for the creation of high-density volumetric displays where thousands of particles like particle 540 can be independently trapped and illuminated by a single integrated platform.

In some implementations, the illumination system 510 is replaced by broad-spectrum incoherent sources, such as sunlight, to eliminate the cost and safety complications of laser sources. To achieve the necessary optical potential, the system utilizes a combination of concentrators, diffusers (to generate sun speckle traps), and apertures for spatial filtering to improve coherence. The collected light may be guided through waveguide concentrators or photonic lanterns to reformat multi-mode solar input into useable trapping beams. The optical system 520 can be configured to construct stable traps using multiple axicons or by the temporal move of a flat-top beam profile to continuously “paint” the trap geometry. This architecture supports sun-driven aerial manufacture; for applications in the vacuum of space, a bubble is inflated to increase pressure to the optimal level required for photophoretic forces, whereas terrestrial versions may reduce pressure to optimize particle lift. Furthermore, the system exploits the full solar spectrum by using filters to separate functions: invisible parts of the spectrum (e.g., infrared) are directed to form the trap structure, while visible parts are filtered to provide specific illumination colors, effectively creating a sun-driven scan display.

To ensure continuous, automated operation, the system incorporates a mechanical particle reservoir mechanism, referred to as a “glass umbrella” or conveyor belt. This component—which may comprise a rotating glass or aluminum substrate coated in soot—physically draws particles from a generation source (such as an air pull flame) and delivers them directly to the trapping region 550. The loading process may utilize various kinematic techniques, including a pull classic, a chain pull, or a two-laser spit action to transfer the particle from the mechanical substrate into the optical beam. By using a conveyor belt that is continuously dip-coated or soot-coated, the system ensures that if a particle is lost, the reservoir immediately replenishes it, maintaining the integrity of the constructed traps without manual intervention.

In some implementations, the system is configured to provide depth-indexed illumination, allowing two particles located within the same optical tube to scatter distinct colors or direct light in distinct directions simultaneously. Unlike flood illumination where all particles in a beam path receive the same light, the present system utilizes the high-speed temporal modulation and spatial addressability of the illumination array (e.g., micro LEDs) to target specific axial depths (z-coordinates).

This per-particle differentiation can be achieved through time-multiplexing. As the “elevator cars” move the particles along the axis, the control system tracks the instantaneous depth of a first particle and a second particle. When the first particle crosses a specific voxel coordinate, the array activates a first set of emitters (e.g., red LEDs) for a microsecond duration. As the second particle subsequently crosses the same or a different coordinate, the array switches to a second set of emitters (e.g., blue LEDs). Because the switching speed of the micro LEDs (nanoseconds) exceeds the integration time of the human eye, the observer perceives two distinct colored voxels at two different depths within the same tube, even if the particles are physically identical.

Alternatively, the system may employ wavelength multiplexing per axial plane using dispersive optics. As illustrated in the description of FIG. 6, the optical system may include holographic optical elements (HOEs) or dispersive prisms that map different wavelengths to different focal depths along the tube axis. In this configuration, a “red” illumination beam naturally focuses at a first depth Z₁, while a “blue” illumination beam focuses at a second depth Z₂. Consequently, a particle passing through Z₁ will only scatter red light, and a particle passing through Z2 will only scatter blue light. This allows for passive, spectrally encoded depth addressing where the color of the scatter is strictly determined by the particle's position in the tube, enabling complex multi-colored volumetric structures to be built from a single stream of identical particles.

In some implementations, the system utilizes the optical tubes to create layered image volumes with independent layer visibility. In this configuration, the display volume is conceptually or physically divided into a plurality of axial planes or “depth layers” (z-planes).

The illumination system is configured to project light selectively into specific planes (e.g., a “light curtain” at depth Z₁) while leaving adjacent planes dark. The visibility of a specific image layer is thus “gated” by the physical position of the particles; a layer becomes visible only when the “elevator cars” transport particles into the illuminated plane.

This architecture allows for explicit layer gating where particles serve as physical switches for voxel visibility. For example, to render a topological map with a floating cloud layer, the system may hold a first set of particles in a dark, non-illuminated “holding zone” at depth Z_{hold} while simultaneously moving a second set of particles into an illuminated “active zone” at depth Z_{display}. Although both sets of particles are trapped and present within the volume, only the second set scatters light to the viewer. To switch the display or reveal hidden information (e.g., revealing the terrain beneath the clouds), the system effectively shuttles the first set of particles into the light and the second set out of it. This method enables the random access display of volumetric data, where entire cross-sections of an object can be flashed on or off instantaneously without the need to re-scan the entire volume, simply by moving matter into the pre-existing “light slice.”

In some implementations, the system 500 is configured to create layered image volumes with independent layer visibility by utilizing depth-selective illumination gating. In this configuration, the illumination system 510 does not flood the entire display volume with light; instead, it projects light selectively into specific axial planes (e.g., generating a “light curtain” or “slice” at a specific depth Z₁) while leaving adjacent planes (e.g., depth Z₂) dark. The visibility of a specific image segment is thus “gated” by the physical position of the particle 540; a voxel becomes visible only when the optical system 520 transports the particle into the illuminated plane. This effectively treats the particle as a physical switch that scatters light to the viewer only when it intersects the active illumination slice, allowing other particles in the same tube to remain invisible while traversing dark regions.

This architecture enables the random access display of volumetric data without the need to mechanically scan the entire volume. As described in the disclosure, the system may maintain a reservoir of particles in non-illuminated “holding zones” or “parking depths” distributed along the beam axis. To render a specific feature—such as a topological layer or a floating object—the system rapidly shuttles specific particles from the dark zones into the “active” illuminated layers. This allows the system to “pull details out of a holographic image” or a dense 3D dataset instantaneously by moving matter into the pre-existing light field, permitting layers to be revealed or hidden independently in a random-access fashion.

FIG. 6 is a diagram illustrating an example system 600 for generating an optical trap using holographic optical elements. This component—which may include a rotating glass or aluminum substrate coated in soot—physically draws particles from a generation source (such as an air pull flame) and delivers them to the trapping region 550. These devices physically pick up particles from a flame or liquid and deliver them simultaneously to the beam to ensure continuous refreshment of the trap. The loading process may utilize various kinematic techniques, including a pull classic, a chain pull, or a two-laser spit action to transfer the particle from the mechanical substrate into the optical beam. By using a conveyor belt that is continuously dip-coated or soot-coated, the system ensures that if a particle is lost, the reservoir immediately replenishes it, maintaining the integrity of the constructed traps without manual intervention.

FIG. 6 illustrates a schematic representation of a solid-state optical trapping and display system 600. The system is designed to overcome the limitations of complex laser-based setups by utilizing high-density incoherent sources coupled with diffractive optics. The primary illumination component is an array of micro LEDs 610. This array serves as the photon engine for the device, comprising thousands or even millions of densely packed light emitters. Unlike traditional macroscopic light sources, this array is capable of high-resolution spatial and temporal modulation, allowing the system to trade off resolution for optical power, directionality, and color depth.

The fundamental unit of the source is the individual micro LED 612. These elements typically have linear dimensions in the range of 1 to 10 microns, allowing them to function effectively as point sources that can be imaged to diffraction-limited spots similar to laser foci. In the operation of the system 600, specific subsets of these individual micro LEDs 612 are activated to generate distinct beams. Because the source is an array, multiple individual elements can be driven simultaneously or sequentially, providing the flexibility to generate completely independent optical potentials for trapping, pushing, or illuminating particles without mechanical movement.

Positioned in the optical path to intercept the light from the source is an array of holographic optical elements 620. This component acts as the beam-shaping interface, often referred to in the specification as a “single modulation surface.” The array of holographic optical elements 620 receives the incoherent illumination emitted by the array of micro LEDs 610 and transforms the diverging wavefronts into structured beams—such as Bessel beams, vortex beams, or focused spots—required for forming a trap. This optical layer effectively replaces bulky conventional lenses and mirrors with a flat, solid-state component.

A specific portion of this surface is designated as an individual holographic optical element 622. This element is configured—typically through diffractive patterns functioning as superimposed lenses and prisms—to image the light from a specific individual micro LED 612 (or a cluster of them) into a precise location in the trap volume. The specification emphasizes that this single modulation surface allows multiple beams to be generated that are each independently responsible for different functions simultaneously. For example, one set of beams generated by the interaction between specific LEDs and the optical elements might trap a particle, while another set simultaneously provides illumination or a “push” force.

In the implementation of FIG. 6, an optical trap can be built by a series of individual micro LEDs 612 imaged to form the physical “walls” of the trap using optical elements such as lenses, prisms, or holograms. Unlike single-beam laser traps, this configuration achieves greater power density by utilizing a “many-to-one” imaging strategy, where the output from a large number of micro LEDs 612 within the array 610 is superimposed to contribute to the walls of a single trap. This aggregation allows the system to overcome the lower brightness of individual incoherent emitters compared to coherent lasers, generating sufficient optical potential to confine the particle.

This “built-wall” trap architecture allows for the opportunity to “paint” different parts of the trap wall with different colors, giving rise to directional scatter from the wall structure itself. For example, by selecting specific micro LEDs 612 to form specific segments of the trap boundary, the system can ensure that light scattered in one direction is red while light scattered in another is green, effectively creating a view-dependent pixel. This directional scatter is also capable of being optimized by choosing particles with specific scattering properties that interact with the colored wall structure.

The optical system 620 can utilize various active or passive mechanisms to direct and combine the micro LEDs 612. In some embodiments, an active spatial light modulator (SLM) is used to direct individual micro LEDs selected in the array 610, allowing the trap configuration to be updated dynamically without the need for additional moving optics. Alternatively, a passive optic can be used to collimate a large number of micro LEDs, after which active or static lenses are used to direct and combine them to create trap walls and to illuminate the particle. The optical system 620 may also include holographic optical elements (HOEs) 622 to combine the sources; these HOEs can be polarization-dependent to combine micro LEDs using polarization, or they can be configured to perform spectral combining, merging multiple wavelengths into a single high-power beam.

Furthermore, the arrays 610 can be adapted to contain “invisible” colors, such as ultraviolet (UV) or infrared (IR), alongside visible emitters. In this configuration, the system utilizes the invisible wavelengths to form the physical trap walls—holding the particle invisibly—and then utilizes the visible micro LEDs 612 to illuminate the particle with visible light. This separation of functions allows the same process to be used to increase the brightness or change the color of a particle's illumination with high precision, as the trapping forces remain constant while the illumination intensity is modulated.

An advantage of this architecture is realized when trapping and illumination are separated, as the illumination function can take advantage of the ultra-high on/off time of micro LEDs, allowing for ultra-high intensity dynamic range and ultra-high color precision. This advantage is compounded by the fact that more and more micro LEDs 612 can dynamically be dedicated to a single trap/particle system. The vast numbers of micro LEDs in an array (e.g., 30,000 or more) can be traded off to get any combination of performance metrics: more trapped particles, more views for a given particle, higher color bit depth, a stiffer trap (higher intensity), or smoother motion.

In the configuration of FIG. 6, the system utilizes the high-density array of micro LEDs 610 to resolve the “light splash” issues (light that misses the particle and hits the background) common in traditional laser-based displays. In conventional systems, if the illumination beam is not perfectly matched to the particle's cross-section, the light that fails to scatter off the particle continues to propagate, resulting in a distracting “splash” of light on background surfaces or creating potential safety hazards for observers. The addressability of the individual micro LEDs 612 allows the system to dynamically trim the beam shape in real-time. If a sensor detects that light from specific illumination elements is passing the particle without scattering (i.e., not falling on the target), the system can immediately deactivate those specific micro LEDs. Simultaneously, adjacent micro LEDs that are better aligned with the particle's instantaneous position can be turned on. This active feedback loop ensures that the illumination is strictly confined to the physical volume of the particle, thereby eliminating background splash and maximizing the safety and contrast of the display. In some implementations, a method to eliminate “light splash” may use sensors to detect when LEDs are not hitting the target and turning those specific pixels off, while turning on adjacent ones.

In the configuration of FIG. 6, the system 600 may, in some implementations, use a sensing feedback control mechanism to resolve “light splash” issues common in volumetric displays. For example, in conventional systems, if the illumination beam is not perfectly matched to the particle's cross-section or position, the light that fails to scatter off the particle continues to propagate, resulting in a distracting “splash” of light on background surfaces or creating potential safety hazards for observers. To mitigate this, the system incorporates a sensor (not explicitly shown but operably coupled to the optical path) configured to detect the scattering efficiency of the illumination. This sensor monitors whether the light emitted by specific micro LEDs 612 is successfully intercepting the target particle or passing it by.

Upon detection that light from specific illumination elements is not falling on the target particle (e.g., detecting a rise in background intensity or a lack of expected scatter), the system triggers an active feedback loop. The controller immediately deactivates the specific micro LEDs contributing to the splash and simultaneously activates adjacent micro LEDs 612 that are better aligned with the particle's instantaneous position. This real-time “trimming” of the beam shape ensures that the illumination is strictly confined to the physical volume of the particle, thereby maximizing the contrast of the display and ensuring that high-intensity light is not projected directly toward an observer's eye, effectively creating a safety interlock through solid-state modulation.

The configuration shown in FIG. 6 enables dynamic beam steering and manipulation through “many-to-one” imaging. By changing which individual micro LED 612 is illuminated behind a fixed individual holographic optical element 622, the angle and position of the output beam can be shifted. Furthermore, because holographic elements are often dispersive, changing the color of the illumination (e.g., from red to blue) can also be used to move the trap or the particle in space. This architecture can produce a robust, solid-state display where the movement of particles and the directionality of scattered light are controlled purely electronically by the source array, eliminating the need for moving parts.

In some implementations, the system is configured to provide random-access addressing of the display volume, allowing for the selective manipulation and illumination of specific volumetric regions (x, y, z), angular view channels, and wavelength channels without the constraints of sequential raster scanning. Unlike systems that must sweep a beam continuously through a trajectory, the present system utilizes the high-speed addressability of the illumination array (e.g., micro LEDs) to achieve random access of depths and regions. For example, to update a specific voxel at coordinates (x₁, y₁, Z₁), the system can activate a specific subset of illumination elements to form a trap or illumination spot solely at that coordinate, leaving the surrounding volume dark. This allows for “sparse updates” where only the changing parts of a 3D image are refreshed, significantly reducing power consumption and bandwidth latency compared to full-volume scans.

This random-access capability extends to the random access of depths (z-axis). As illustrated in the source descriptions for FIG. 5, independent particles in the optical tubes can be used to make specific layered image volumes visible in a random-access fashion. In one embodiment, particles are distributed along the length of the tube at various “parking” depths.

The system can randomly access a specific depth layer by triggering the illumination system only when a particle is present at the desired z-plane, or by using a “push-pull” optical force (e.g., a dynamic micro LED spot acting against a static VCSEL tube) to rapidly shuttle a particle to a target depth independent of the particles in adjacent tubes. This allows the display to render disjointed 3D features—such as a cloud floating above a map—without scanning the empty space between them.

Furthermore, the system provides explicit addressing of angular view channels and wavelength channels. Because the source array supports “many-to-one” imaging, the system can independently select which specific illumination elements contribute to a single voxel. For instance, to create a view-dependent voxel that appears red to a user at 45° and blue to a user at −45°, the system simultaneously activates “red” micro LEDs located at a corresponding source angle θ₁ and “blue” micro LEDs at source angle θ₂. These beams converge on the same particle but scatter in different directions based on the angle of incidence. This effectively treats “viewing angle” as a programmable channel similar to color (RGB), enabling the system to synthesize light fields where (x, y, x, θ, φ, λ) are all independent, randomly accessible variables.

In the implementation of FIG. 6, the system 600 may be configured such that the array of micro LEDs 610 operates in conjunction with vertical-cavity surface-emitting laser (VCSEL) arrays to create robust optical tubes and illumination fields. These technologies are well-situated to work together; for instance, a high-power VCSEL array may be utilized to generate static, high-stiffness “line traps” or optical tubes, while the highly addressable array of micro LEDs 610 provides dynamic control for manipulation and illumination. These line traps can be formed by focusing the output of the emitters through specific optical elements 620, such as axicons, to create Bessel beams, or they may be generated via temporal manipulation. In a temporal setup, the system utilizes the high-speed switching of the micro LEDs 612 to “paint” the trap walls faster than the particle's relaxation time, effectively creating a continuous barrier through persistence of excitation.

Various “push-pull” configurations can be achieved by combining these sources. In one embodiment, a static optical tube is formed by a VCSEL array to laterally confine the particle, while a separate “pushing” beam is provided by a specific micro LED spot or a second VCSEL element directed along the tube's axis. Alternatively, the system can employ a “tube plus moving micro LED trap” configuration, where the tube provides the track and dynamic micro LED patterns (functioning as the “elevator cars”) provide the axial transport mechanism. This allows the system to separate the functions of confinement and transport between different optical sources to optimize power efficiency and control resolution/

The system can also exploit natural forces to simplify the optical requirements. For example, gravity can serve as a restoring force against an optical push; the system may use an emitter to push a particle upward within the tube, and by modulating the intensity of the push beam, allow gravity to pull the particle back down, creating a predictable oscillation without requiring a dedicated “pull” beam. Furthermore, because incoherent sources can provide broad area illumination, a single large LED or a cluster of micro LEDs can be configured to “push” on multiple tubes at once. This allows for global manipulation of a field of particles while maintaining individual lateral confinement within their respective optical tubes.

To ensure continuous operation, the system 600 may incorporate physical or optical hoppers, or even inkjet arrays, to provide a steady feed of particles into the multiple tubes. A specialized “optical hopper” can be constructed using vortex beams generated by passing light through a phase plate and a combining lens. In this configuration, the specific feed angles of the hopper can be tuned by the optics; for example, a higher angle phase plate combined with a higher power combining lens can create a steeper hopper geometry, effectively guiding particles into the capture volume of the line trap from a wider reservoir area.

Also, all the trapping and manipulation mechanisms described above—including the use of VCSEL tubes, micro LED pushing spots, and vortex hoppers—can be executed in partial pressure environments. Operating in a partial vacuum or controlled gas atmosphere significantly loosens the power requirements for the system, as photophoretic forces (which rely on gas interaction) can be optimized relative to air resistance and gravity. This environmental control allows the array of micro LEDs 610 and supporting VCSELs to trap and move particles with lower optical power, reducing thermal management needs and enabling the use of lower-cost emitter arrays.

In some implementations, the system is configured to move a first particle and a second particle within the same optical tube independently, such that they may move in different directions or velocities (e.g., the first particle moves upward while the second particle moves downward or remains stationary). Unlike the “unison” movement achieved by shifting a single interference pattern, this independent control is achieved by superposing multiple, independently modulated beam components along the same axis. For example, the illumination source (e.g., the microLED array) or the second optical system (e.g., the SLM) may generate a composite beam comprising a first set of trapping nodes (controlled by a first phase pattern or frequency) and a second set of trapping nodes (controlled by a second phase pattern or frequency). The first particle is localized within the first set of nodes, and the second particle is localized within the second set. By independently modulating the phase or position of the first pattern relative to the second, the system allows for the “collision” or “passing” of particles within the same physical beam volume.

In another implementation, specifically detailed in the context of hybrid source arrays (e.g., VCSEL plus micro LED), the system separates lateral confinement from axial transport to achieve independent motion. As illustrated in the source materials regarding VCSEL Arrays, a high-power static source (such as a VCSEL array) generates a continuous, static optical tube that provides only lateral confinement (the “walls”) without defined “floors” or “ceilings.” Simultaneously, a highly addressable dynamic source (such as a micro LED array or scanning laser) projects independent, localized “pushing” spots or “optical tweezers” into the tube. Because the dynamic source can address specific voxel depths (z-coordinates) individually—or utilize gravity as a restoring force against a unidirectional push—the system can exert an upward force on a bottom particle while exerting a downward force (or no force) on a top particle. This effectively turns the optical tube into a passive guideway (similar to a rail) on which independent “optical engines” drive separate particles.

In some implementations, the optical structures generated by the single modulation surface (e.g., the array of holographic optical elements 620) are configured to serve multiple physical functions simultaneously within the same volumetric space. Rather than utilizing separate hardware for trapping and illumination, the system synthesizes “multifunctional voxels” where the high-intensity regions defining the trap geometry also constitute the active payload of the display or manufacturing process.

In a specific embodiment regarding volumetric display, the system constructs “colored floor/ceiling pairs” within the optical tubes. As described previously, the “floors” and “ceilings” are regions of high light intensity that axially confine the particle. Here, the system utilizes specific wavelengths to form these barriers such that they simultaneously trap the particle and determine its apparent color. For example, the system may generate a “green tube” where the high-intensity walls, floors, and ceilings are formed entirely of green light (e.g., 532 nm). Alternatively, the system may superimpose a “purple” floor/ceiling pair (formed by combining red and blue emitter elements) within a green tube. In this configuration, the green tube provides lateral confinement, while the purple floors and ceilings provide axial confinement and scattering illumination. This allows for complex color mixing where the trapping structure itself acts as the display pixel. Furthermore, the “walls” of the trap can be constructed with a multicolor structure; by imaging red micro LEDs to form the left side of the trap wall and blue micro LEDs to form the right side, the system creates a directionally scattering voxel that appears red from one viewing angle and blue from another.

In aerial additive manufacturing embodiments, the system utilizes spectral separation to decouple the mechanical manipulation of material from chemical activation. This enables a specific “trap-then-cure” workflow for assembling multi-resin structures in mid-air. 1. Trapping Wavelength (IR): The system first activates illumination elements emitting a non-reactive “trapping wavelength” (e.g., Infrared or IR). These beams generate the necessary photophoretic or optical gradient forces to trap uncured resin particles and mechanically drive them together within the optical tube. Because the resin is transparent to or non-reactive with IR, the particles can be manipulated without premature hardening. 2. Cure Wavelength (UV): Once the disparate resin particles are brought into physical contact at the target voxel coordinate, the system selectively activates illumination elements emitting a “cure wavelength” (e.g., Ultraviolet or UV). This UV light is directed solely into the collision zone, instantly cross-linking or polymerizing the resin to bond the particles together. This architecture provides spatial selectivity per voxel, ensuring that material properties are altered only when and where specific particles intersect specific “curing” beams. The system can effectively “print” free-floating objects by bringing reactants together with invisible IR tweezers and fusing them with UV spot-welds, all directed from the same solid-state array.

Example 1. A system, comprising: a source configured to produce electromagnetic radiation; a first optical system configured to form a beam from the electromagnetic radiation produced by the source, the beam having an intensity profile along an axis, the beam causing a first particle to be localized at a first minimum of the intensity profile along the axis and a second particle to be localized at a second minimum of the intensity profile along the axis; and a second optical system configured to cause the first particle and the second particle to move along the axis by moving the first minimum and the second minimum along the axis.

Example 2. The system as in example 1, wherein the first optical system is further configured to confine the first particle within a first volumetric region within the beam and the second particle within a second volumetric region within the beam, the first volumetric region being separate from the second volumetric region.

Example 3. The system as in example 2, wherein the second optical system is configured to cause the first volumetric region and the second volumetric region to move along the axis, the first volumetric region remaining separate from the second volumetric region as the first volumetric region and the second volumetric region move along the axis.

Example 4. The system as in example 1, wherein the second optical system is configured to move the first minimum and the second minimum separately, some or one at a time, or in unison.

Example 5. The system as in example 1, wherein the first optical system includes a first optical element configured to produce a first Bessel beam and a second optical element configured to produce a second Bessel beam; and wherein the beam includes a combination of the first Bessel beam and the second Bessel beam.

Example 6. The system as in example 5, wherein the first optical element is a first axicon and the second optical element is a second axicon.

Example 7. The system as in example 6, wherein the second axicon is superposed on the first axicon.

Example 8. The system as in example 6, wherein the second axicon has an apex angle greater than an apex angle of the first axicon.

Example 9. The system as in example 1, wherein the second optical system is further configured to change a phase of rays of the electromagnetic radiation produced by the source.

Example 10. The system as in example 9, wherein the second optical system includes a spatial light modulator.

Example 11. A method, comprising: forming a beam from electromagnetic radiation produced by a source, the beam having an intensity profile along an axis, the beam causing a first particle to be localized at a first minimum of the intensity profile along the axis and a second particle to be localized at a second minimum of the intensity profile along the axis; and causing the first particle and the second particle to move along the axis by moving the first minimum and the second minimum along the axis.

Example 12. The method as in example 11, further comprising: confining the first particle within a first volumetric region within the beam and the second particle within a second volumetric region within the beam, the first volumetric region being separate from the second volumetric region.

Example 13. The method as in example 12, further comprising: causing the first volumetric region and the second volumetric region to move along the axis, the first volumetric region remaining separate from the second volumetric region as the first volumetric region and the second volumetric region move along the axis.

Example 14. The method as in example 11, further comprising: moving the first minimum and the second minimum separately, some or one at a time, or in unison.

Example 15. The method as in example 11, wherein the beam includes a combination of a first Bessel beam and a second Bessel beam.

Example 16. A system, comprising: an illumination source including an array of illumination elements, the array of illumination elements being configured to produce incoherent illumination; and an optical system configured to form a first beam from the incoherent illumination produced by first illumination elements of the array of illumination elements and a second beam from the incoherent illumination produced by second illumination elements of the array of illumination elements, the optical system being further configured to combine the first beam and the second beam to form a region about foci of the first beam and the second beam in which a particle is localized.

Example 17. The system as in example 16, wherein the optical system includes a set of holographic optical elements.

Example 18. The system as in example 17, wherein the optical system is further configured to cause the particle to move in space by changing a color of incoherent illumination incident on a holographic optical element.

Example 19. The system as in example 16, wherein the array of illumination elements includes an array of micro light-emitting diodes.

Example 20. The system as in example 19, wherein the first beam has a first color and the second beam has a second color.

Example 21. A system, comprising: a source configured to produce electromagnetic radiation; an optical system configured to form a composite beam structure along an axis, the composite beam structure defining a first trapping region at a first axial position and a second trapping region at a second axial position; wherein the optical system is configured to independently translate the first trapping region and the second trapping region along the axis such that a first particle confined in the first trapping region moves in a first direction while a second particle confined in the second trapping region simultaneously moves in a second direction different from the first direction, or remains stationary.

Example 22. The system as in example 21, wherein the source includes: a first emitter array configured to generate a static optical tube providing lateral confinement for the first particle and the second particle; and a second emitter array configured to project independently addressable focal spots into the static optical tube to provide an axial force to the first particle and the second particle respectively.

Example 23. The system as in example 21, wherein the optical system utilizes temporal multiplexing to alternate between generating the first trapping region and the second trapping region at a rate faster than a relaxation time of the first particle and the second particle.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining or displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A system, comprising:
a source configured to produce electromagnetic radiation;
a first optical system configured to form a beam from the electromagnetic radiation produced by the source, the beam having an intensity profile along an axis, the beam causing a first particle to be localized at a first minimum of the intensity profile along the axis and a second particle to be localized at a second minimum of the intensity profile along the axis; and
a second optical system configured to cause the first particle and the second particle to move along the axis by moving the first minimum and the second minimum along the axis.

2. The system as in claim 1, wherein the first optical system is further configured to confine the first particle within a first volumetric region within the beam and the second particle within a second volumetric region within the beam, the first volumetric region being separate from the second volumetric region.

3. The system as in claim 2, wherein the second optical system is configured to cause the first volumetric region and the second volumetric region to move along the axis, the first volumetric region remaining separate from the second volumetric region as the first volumetric region and the second volumetric region move along the axis.

4. The system as in claim 1, wherein the second optical system is configured to move the first minimum and the second minimum separately, some or one at a time, or in unison.

5. The system as in claim 1, wherein the first optical system includes a first optical element configured to produce a first Bessel beam and a second optical element configured to produce a second Bessel beam; and
wherein the beam includes a combination of the first Bessel beam and the second Bessel beam.

6. The system as in claim 5, wherein the first optical element is a first axicon and the second optical element is a second axicon.

7. The system as in claim 6, wherein the second axicon is superposed on the first axicon.

8. The system as in claim 6, wherein the second axicon has an apex angle greater than an apex angle of the first axicon.

9. The system as in claim 1, wherein the second optical system is further configured to change a phase of rays of the electromagnetic radiation produced by the source.

10. The system as in claim 9, wherein the second optical system includes a spatial light modulator.

11. A method, comprising:
forming a beam from electromagnetic radiation produced by a source, the beam having an intensity profile along an axis, the beam causing a first particle to be localized at a first minimum of the intensity profile along the axis and a second particle to be localized at a second minimum of the intensity profile along the axis; and
causing the first particle and the second particle to move along the axis by moving the first minimum and the second minimum along the axis.

12. The method as in claim 11, further comprising:
confining the first particle within a first volumetric region within the beam and the second particle within a second volumetric region within the beam, the first volumetric region being separate from the second volumetric region.

13. The method as in claim 12, further comprising:
causing the first volumetric region and the second volumetric region to move along the axis, the first volumetric region remaining separate from the second volumetric region as the first volumetric region and the second volumetric region move along the axis.

14. The method as in claim 11, further comprising:
moving the first minimum and the second minimum separately, some or one at a time, or in unison.

15. The method as in claim 11, wherein the beam includes a combination of a first Bessel beam and a second Bessel beam.

16. A system, comprising:
an illumination source including an array of illumination elements, the array of illumination elements being configured to produce incoherent illumination; and
an optical system configured to form a first beam from the incoherent illumination produced by first illumination elements of the array of illumination elements and a second beam from the incoherent illumination produced by second illumination elements of the array of illumination elements, the optical system being further configured to combine the first beam and the second beam to form a region about foci of the first beam and the second beam in which a particle is localized.

17. The system as in claim 16, wherein the optical system includes a set of holographic optical elements.

18. The system as in claim 17, wherein the optical system is further configured to cause the particle to move in space by changing a color of incoherent illumination incident on a holographic optical element.

19. The system as in claim 16, wherein the array of illumination elements includes an array of micro light-emitting diodes.

20. The system as in claim 19, wherein the first beam has a first color and the second beam has a second color.

21. A system, comprising:
a source configured to produce electromagnetic radiation;
an optical system configured to form a composite beam structure along an axis, the composite beam structure defining a first trapping region at a first axial position and a second trapping region at a second axial position;
wherein the optical system is configured to independently translate the first trapping region and the second trapping region along the axis such that a first particle confined in the first trapping region moves in a first direction while a second particle confined in the second trapping region simultaneously moves in a second direction different from the first direction, or remains stationary.

22. The system as in claim 21, wherein the source includes:
a first emitter array configured to generate a static optical tube providing lateral confinement for the first particle and the second particle; and
a second emitter array configured to project independently addressable focal spots into the static optical tube to provide an axial force to the first particle and the second particle respectively.

23. The system as in claim 21, wherein the optical system utilizes temporal multiplexing to alternate between generating the first trapping region and the second trapping region at a rate faster than a relaxation time of the first particle and the second particle.
